(19) United States
(12) Patent Application Publication
(10) Pub. No.: US 2007/0247519 A1
(43) Pub. Date: Oct. 25, 2007

(54) Display System with Moving Pixels for 2D and 3D Image Formation

(75) Inventors: Majid Riaziat, San Jose, CA (US); Thomas H. Tie, Concord, CA (US); Andrew P. Aitken, Sunnyvale, CA (US)

Correspondence Address: HAYNES BEFFEL & WOLFELD LLP, P O BOX 366, HALF MOON BAY, CA, 94019, US

(73) Assignee: WAG DISPLAY CORPORATION, INC., Concord, CA (US)

(21) Appl. No.: 11/569,661

(22) PCT Filed: Mar. 6, 2006
(86) PCT No.: PCT/US06/07979

§ 371 Date: Nov. 27, 2006

Related U.S. Application Data
(60) Provisional application No. 60/658,980, filed on Mar. 5, 2005.
(60) Provisional application No. 60/658,979, filed on Mar. 5, 2005.
(60) Provisional application No. 60/658,978, filed on Mar. 5, 2005.

(51) Int. Cl. H04N 7/00; H04N 15/00

(52) U.S. Cl. 348/37; 348/51; 348/E07.091; 348/E15.001

(57) ABSTRACT

Various embodiments of displays form a multi-dimensional image with moving pixels.

### BACKGROUND OF THE INVENTION

### Description of Related Art

Display technology that forms an image with light sources that rotate about an axis has the advantage of being viewable from a wider range angle than a conventional display. Although an arrangement of multiple conventional displays placed together at angles is also viewable from a wide range of angles, the displayed images are less immersive, because the displayed images are interrupted by the frames of the displays themselves. Existing rotating display technology, however, has many disadvantages. Commonly, the light sources are positioned about the perimeter of a spinning frame. This arrangement restricts the size and shape of each pixel, as well as the distribution of the angular momentum in the rotating system. Such displays also present a two-dimensional image, and also do not present a panoramic image. Thus, a need exists for various displays that address such needs with some combination of a panoramic display, a display that is lighter, and a three-dimensional display.

### SUMMARY OF THE INVENTION

One embodiment of a moving display includes a frame surrounding an image viewing area; and optical assemblies mounted on the frame to move around the image viewing area.

The frame forms a circular or non-circular path around the image viewing area. The optical assembly moves around the image viewing area along this path.

Another embodiment of a display includes a frame, an autostereoscopic element directing incident optical energy, such that a multi-dimensional image from the depth perception screen appears three-dimensional, and optical assemblies. The three-dimensional information is generated by modulation of the optical sources. Multiple images are radiated by each of the optical sources as multiple pixels in rapid succession. The autostereoscopic element such as a lenticular screen or parallax screen helps to direct the proper image to the corresponding eye.

Yet another embodiment of a display includes a frame and optical assemblies mounted on the frame to make a periodic motion about an axis.

Each optical assembly has optical sources that radiate optical energy to be viewed from the image viewing area. One embodiment uses LEDs as the optical sources. Each optical assembly also has circuitry coupled to the optical sources to modulate the optical energy radiated by the optical sources with data of a multi-dimensional image to be viewed, such as in the image viewing area or on the depth perception screen. In various embodiments, the circuitry modulates the optical sources such that the multi-dimensional image appears two-dimensional, layered, or three-dimensional. The multi-dimensional image is defined by the optical energy radiated by the optical sources as the optical assemblies move (e.g., around the image viewing area or relative to the depth perception screen). Depending on the implementation, such as the speed at which the optical assemblies move, there may be one optical assembly or multiple optical assemblies.

In some embodiments, each optical assembly includes optical conduits. Each optical conduit has an inner end optically coupled to at least one of the optical sources to receive optical energy, a body conveying the optical energy received by the inner end, and an outer end radiating the optical energy conveyed by the body to be viewed from the image viewing area or depth perception screen. One embodiment uses optical fibers as the optical conduits. In an embodiment where the optical sources are arranged in groups that radiate differently distributed optical energy (e.g., red/green/blue, red/green/blue/white), the optical energy leaving the outer end of the optical conduits is a mixture of the differently distributed optical energy radiated from the group of optical sources.

In some embodiments, the multi-dimensional image appears to have a depth dimension. Optical energy is radiated by some of the optical sources to be perceived from the image viewing area at a first distance, and is radiated by other optical sources to be perceived from the image viewing area at a second distance. For example, the optical energy may be conveyed by optical conduits of varying length, or radiated by optical sources at different distances from the viewing area. The number of perceived layers is limited only by the number of varying distances at which the optical energy is perceived, such as the number of varying lengths of optical conduits, or by varying distances from the viewing area at which the optical sources are mounted.

In some embodiments, the multi-dimensional image is formed with the aid of a screen, such as a lenticular screen or a parallax screen to direct the proper part of a three-dimensional image to the corresponding eye. The final image as perceived by a viewer has parallax depth information. In some embodiments, the optical assembly circuitry modulates the optical energy radiated by the optical sources with multiple multi-dimensional images, such that each part of the depth perception screen shows a different one of the multiple multi-dimensional image.

Various embodiments include energy shaping elements that control spreading of the optical energy radiated from the optical assemblies or optical conduits in a direction toward the viewer or toward the depth perception screen.

Further embodiments cover corresponding methods and apparatuses including means for modulating optical energy and means for moving the optical sources or optical conduits as described herein.

### BRIEF DESCRIPTION OF THE DRAWINGS

FIG. 1 shows one embodiment of a moving display with optical conduits.

FIG. 2 shows an example of a cluster of 3 LED sources coupled by a coupling device into an optical conduit.

FIG. 3 shows an embodiment with layered images formed at various depths, using multiple arrays with different fiber lengths.

FIG. 4 shows an embodiment of a circular rotating display with one or multiple linear arrays of LEDs.

FIG. 5 shows an embodiment of a circular rotating display with one or multiple linear arrays of optical conduits.

FIG. 6 shows an embodiment of a circular rotating display with multiple light arrays rotating in different, parallel planes to form an overall image with multiple depths.

FIG. 7 shows an embodiment of a panoramic display.

FIG. 8 shows an embodiment of a panoramic display with a noncircular panoramic image.

FIG. 9 shows an embodiment of an optical assembly.

FIG. 10 shows an embodiment of a panoramic display showing a spherical image.

FIG. 11 shows an embodiment of a rotating display that forms a three-dimensional image.

FIG. 12 shows the blank region and the autostereoscopic region of an autostereoscopic display.

FIG. 13 shows an example of a lenticular screen that projects different images at different viewing angles, via time-multiplexing.

FIG. 14 shows optical conduits carrying separate images through a screen for the right and left eyes of an observer.

FIG. 15 shows an example of an optical fiber 1510 with a concave or convex end.

FIG. 16 shows an example of array of optical fibers 1520 with an array of lenses 1530.

### DETAILED DESCRIPTION

FIG. 1 shows one embodiment of a moving display with optical conduits. The cylindrical rotating display includes arrays of optical conduits, which in this embodiment are optical fibers (11). The free ends of the optical fibers (11) point outward from a respective control board (14) mounted on a rotating shaft (12) as part of a rotating assembly. Rigid supports (13) to keep the optical fibers firmly in place. The control board (14) includes the circuitry that delivers electrical power to each light source and controls its intensity as a function of time as required for image formation. A video signal is transmitted to the control boards, and a lighting sequence is emitted from the LED clusters, that in turn is mixed and delivered by the optical conduits, resulting in the display of an image with each image pixel corresponding to the light output of an optical conduit at a particular position of rotation. Light refers generally to electromagnetic energy in the visible spectrum, but in some embodiments light sources radiate outside the visible spectrum, such as in the infrared and ultraviolet.

The control board in this embodiment is a PCB, on which are mounted LEDs that produce the lighting necessary for imagery. The LED PCB has multiple clusters of RGB (red green blue), WRGB (white red green blue), or any combination of LED types, depending on the desired effect of the display. Each cluster of LEDs provides the light for a single optical conduit or a single pixel at any given instance. The cluster is physically arranged for efficient coupling to the optical conduit. Another embodiment separates control circuitry and the LEDs into different boards.

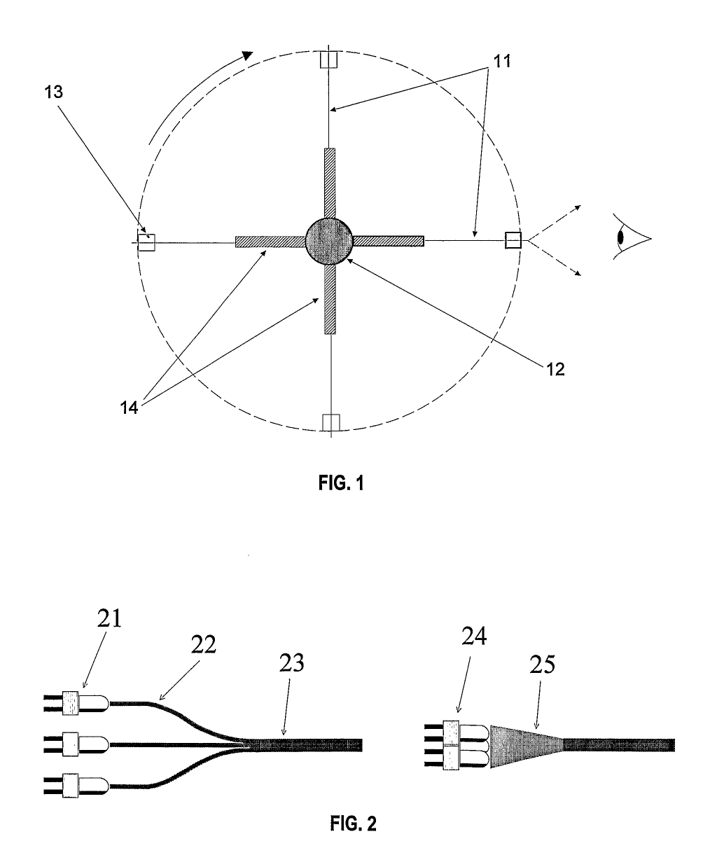

In some embodiments, each cluster has each LED located as close to one another as possible. Each cluster is attached to a coupling device designed to funnel the light from the LEDs of the cluster to the tip of the inlet end of the corresponding optical conduit. FIG. 2 shows two examples of a cluster of LED sources coupled by a coupling device into an optical conduit. In the example on the left, a cluster of 3 LED sources (21) is coupled by a coupling device (22) into an optical conduit (23). In the example on the right, a cluster of 2 LEDs (24) is coupled by a coupling device (25) into an optical conduit (23).

The optical conduit delivers the light from the RGB cluster, from one end of the optical conduit, through the body of the optical conduit, and out the other end of the optical conduit, to a fixed point and form a single pixel. In various embodiments, the optical conduit is substantially straight, or is physically conformed to reach an end point in a predetermined alignment scheme. The conduit is made of optically transparent material Various embodiments include fiber optics, glass rods, materials encased in cladding, and plastics with light propagation properties. The optical conduit premixes the light prior to visualization by the human eye. This may reduce flicker and produce a sharper, crisper image particularly at lower scanning rates.

The optical conduit delivers and mixes the light emitted from the LED hoard to a position in the image. The size, or cross-section, of the optical conduit is determined by the resolution or the pixel size of the image to be produced. In some embodiments, the optical conduit is shaped (or physically manipulated) to deliver the light from the corresponding LED cluster to a location where each optical conduit is prearranged into a sequence. The optical conduits are held in a straight line with other light conduits by rigid support, such as an alignment bar. For example, 50 of the 0.020 inch optical conduits, each coupled to a cluster, delivers an image with a resolution of 50 lines per inch. Various embodiments have a particular cross-section of optical conduit depending on the resolution, and have a particular total number of optical conduits depending on the total number of lines. Optical conduits can be packed more closely than the optical sources. This is because the conduits don't have constraints of electrical connection and heat dissipation, and they can be tapered down to the desired size. So, by using conduits a higher resolution image can be formed compared to an image whose pixels are formed directly by optical sources.

A rotational stage rotates the LED boards along with the coupled optical conduits at a controlled speed. One embodiment drives the rotational shaft (12) using a rotational staging device with a stepper, servo, or direct drive motors depending on the required rpm. Another embodiment is a magnetically driven rotational device using a method similar to changing flux through a coil of wire and causing a potential difference two points. A variation of this is called a linear motor. Such a method is advantageous when space within the display is limited, for example in an installation of the display on a column, e.g., an existing building column.

The whole rotating assembly rotates rapidly enough for 20 to 40 lines of conduits (in optical conduit assemblies) to pass in front of the observer per second, so that the observer sees a continuous image. This will produce an image at 20 to 40 frames per second. An encoding device or other appropriate sensing device monitors rotation and position.

The number of conduit arrays determines the speed of rotation to obtain the number of frames per second required. For example, one array represents a speed of about 2400 rpm, and with four arrays the required rotational speed drops to 600 rpm.

The embodiment shown in FIG. 1 has four optical fiber assemblies, each having an array of optical fibers (11), a control board (14), and a rigid support (13); so this embodiment requires one-fourth the rotation rate of an embodiment with a single optical conduit assembly, while maintaining the same image quality. Various other embodiments have different combinations of rotation speed and the number of optical assemblies, by raising the number of optical assemblies and lowering rotation speed in tandem, or lowering the number of optical assemblies and raising the rotation speed in tandem. Further embodiments improve the image quality by raising the number of optical assemblies without a correspondingly degree of lowering the rotation speed, or raising the rotation speed without a corresponding degree of lowering the number of optical assemblies. Yet further embodiments lower the image quality by lowering the number of optical assemblies without a corresponding degree of raising the rotation speed, or lowering the rotation speed without a corresponding degree of raising the number of optical assemblies. In another embodiment, optical conduit assemblies are physically arranged with a one vertical pixel offset, to form an interlaced image.

Imagery circuitry produces signals for the imagery, which in turn modulate the light sources. The imagery circuitry converts standard video signals for display. In an alternative embodiment, conversion of the video signal into a format more native to the display is done outside of the display itself. The imagery circuitry is located on each of the control boards (14). The signal source of the imagery signals that modulate the imagery circuitry may be located within the display itself, or generated remotely and received by the display. For example, the signal source may be portable magnetic or optical media read by the display, or an electrical, optical, or wireless signal received by the display. Within the display itself, the source image signals are transmitted to the LED boards wirelessly or by electrical or optical cable.

Electricity to power the light sources and the pc boards may pass through a “slip ring” or may be generated by magnetic induction. Another approach is to send the required power by a laser beam that is converted to electricity by a photodetector located in the moving assembly.

In one embodiment, live motion picture information is sent to the moving image-forming parts by wireless transmission, although a “slip-ring” type of signal transmission is also possible. Another embodiment sends the image information by a modulated optical signal via “free space optical transmission”.

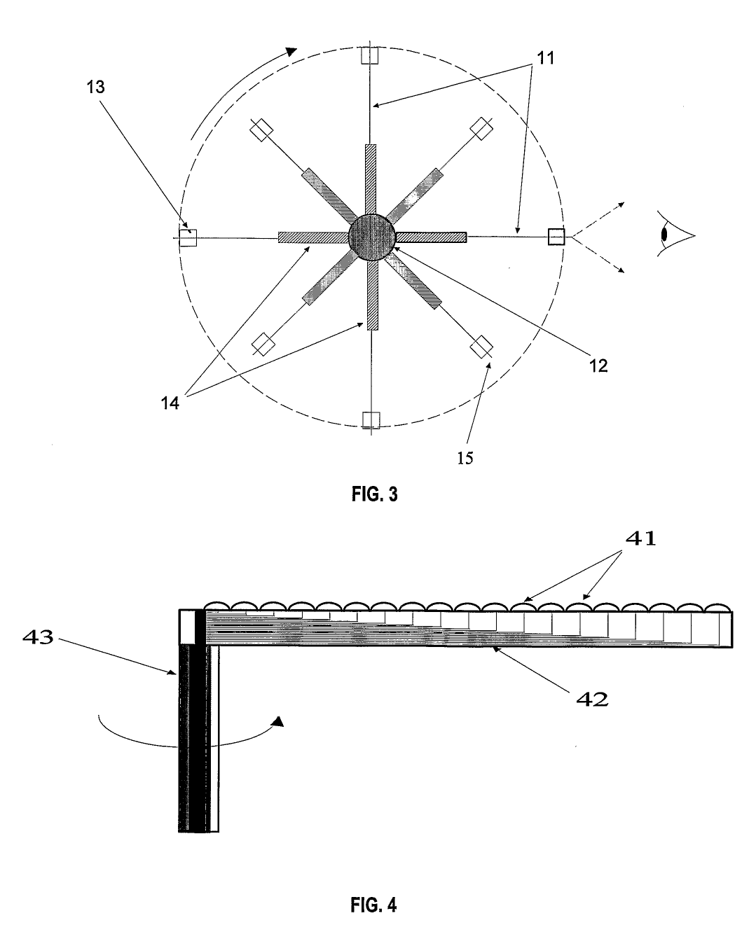

FIG. 3 shows an embodiment with layered images formed at various depths, using multiple arrays with different fiber lengths. Optical fiber array 15 has optical fibers with a shorter length than in optical fiber array 11. The resulting image formed by the optical fiber arrays 15 and the multiple optical fiber arrays 11 appears to have a depth dimension, with the image portion formed by the optical fiber arrays 15 in the background, and the image portion formed by the optical fiber arrays 11 in the foreground. Other embodiments add additional layers by adding additional optical assemblies with optical fibers having a length different from that of optical fiber arrays 11 and 15. The shown embodiment includes only fibers of the same length in any particular optical fiber array, which is more easily manufactured. Another embodiment mixes fibers of different lengths in the same optical fiber array, which lends more flexibility to the array design and image coding.

The dimensions of the image may follow the standard 9:16 aspect ratio used by HDTV, or the 4:3 aspect ratio followed by older televisions, or any other format more suitable to curved display systems. In an embodiment using standard image dimensions are used, it is envisioned that the image may be repeated on the circumference of a cylindrical display. Alternatively, the display size is determined by the location of the display, such as the size of a column around which the display is mounted. This vertical dimension corresponds to the length of the optical conduit assembly and the number of elements used. The diameter, and therefore essentially the circumference, is determined substantially by the distance of the LED board from the axis of rotation and the length of the optical conduit coupled to the LED board. Compared to conventional displays, the moving display is relatively light in an embodiment with components of low weights, in particular the circuit boards and optical conduits. In some embodiments, the heaviest component of the display is the rotational stage portion. However, since the load capacity requirement for the rotational device is lowered due to the relatively light weight of the optical conduits, a large and robust rotational stage may be unnecessary.

One embodiment of the display is placed on a column structure, such as a building column, in particular with such an embodiment having a magnetically driven rotational conduit assembly.

FIG. 4 shows an embodiment of a circular rotating display with one or multiple linear arrays of LEDs (41) that rotate in a plane to form a flat video image. Electrical connections to each LED array are made through a printed circuit board (42). The arrays are connected to a rotating shaft (43). When viewed perpendicular to the plane of rotation, the image is circular in shape.

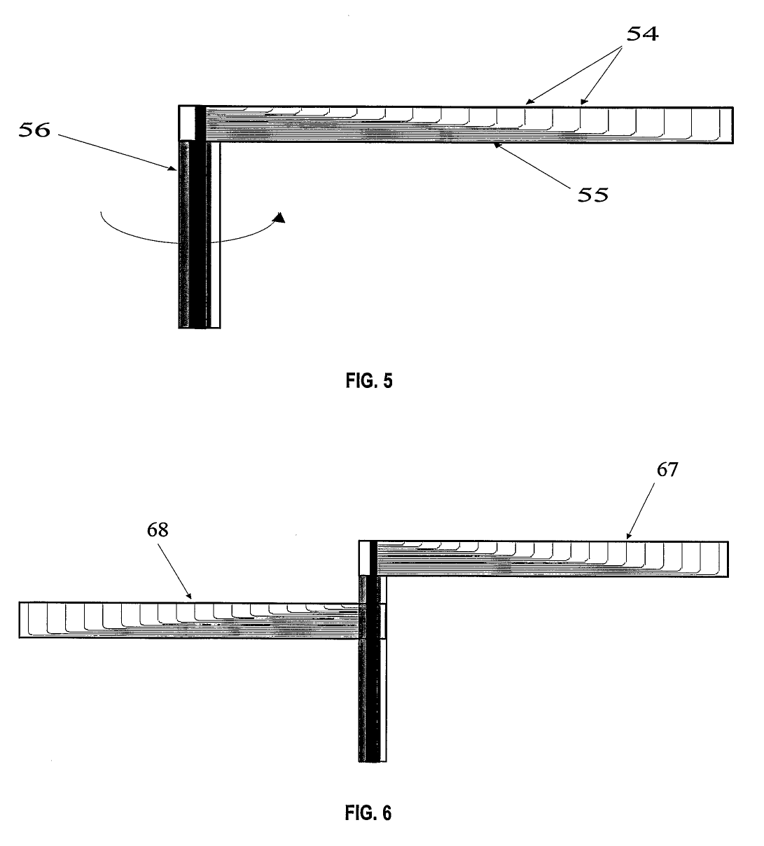

FIG. 5 shows an embodiment of a circular rotating display with one or multiple linear arrays of optical conduits (54) that are formed into a bundle (55) and fed through the rotating shaft (56) to connect to the LEDs. The flat video image is formed by the light leaving the ends of the optical conduits (44).

FIG. 6 shows an embodiment of a circular rotating display with multiple light arrays (67, 68) placed at different positions along the rotating shaft to rotate in parallel planes. Each parallel plane forms part of the image at another depth, forming an overall image with multiple depths. A small region near the center does not have images at multiple depths.

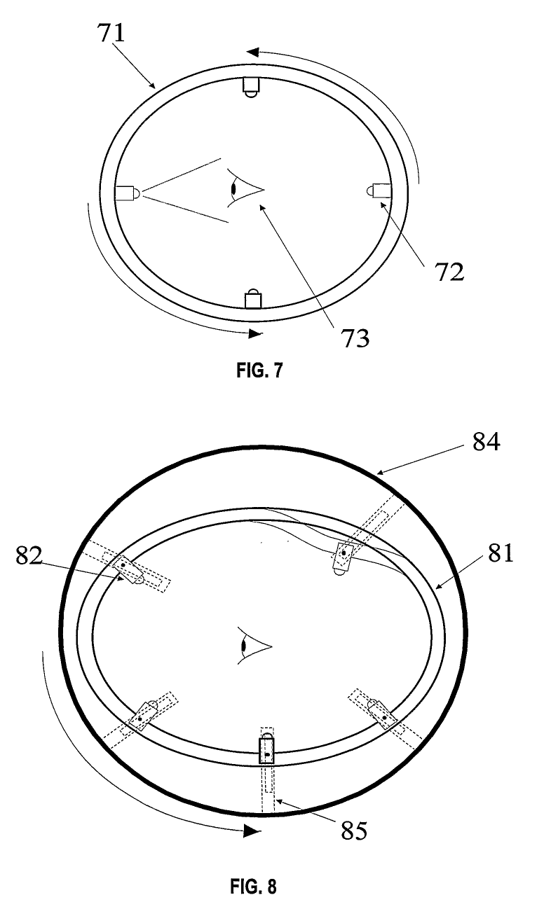

FIG. 7 shows an embodiment of a panoramic display. The panoramic image is formed as a moving assembly moves one or more optical assemblies that about a concave image observation area. Alternatively, the optical assemblies (72) are driven along rails (71) that form a path around the image observation area (73). Because the image is formed by continuously moving optical assemblies, the panoramic image is seamless and free of the image artifacts associated with a panoramic image formed by adjacently positioning together multiple, discrete image displays. Each optical assembly is a bar of LEDs, or an array of optical fibers illuminated by LEDs. Depending on the shape of the moving assembly or rails, the shape of the panoramic image is some concave shape, such cylindrical or spherical.

Potential applications of the immersive panoramic display include interactive games such as massively multiplayer online role playing games (MMORPG) and gambling games, and simulations for battlefield practice, law-enforcement and other training purposes.

FIG. 8 shows an embodiment of a panoramic display with a noncircular panoramic image. The optical assemblies (82) are driven around the image observation area along a noncircular rail path (81) by the rotating cylinder (84). The rotating cylinder (84) is attached to the optical assemblies (82) by slotted support bars (85). The motion associated with a moving display is not necessarily a rotation, in the sense that the optical assembly in some embodiments follows a noncircular path.

Various panoramic display system embodiments form an image with a single layer, or multiple layers at different depths. Multiple layers are formed by varying the dimensions of different optical assemblies or by using multiple guiding rails.

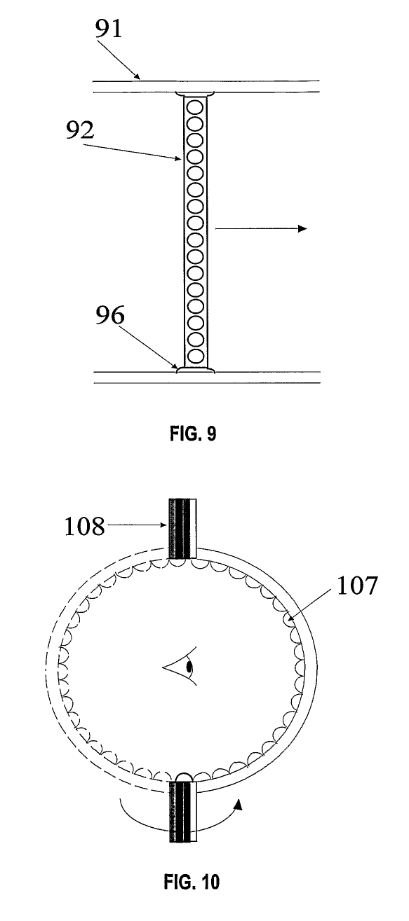

FIG. 9 shows an embodiment of an optical assembly (92). A linear motor and position encoder (96) moves the optical assembly (92) along the rails (91). Injected current of the linear motor (96) controls the speed of the optical assembly (92). Position sensors ensure that the proper pixels of the image are shown at the proper location along the rail. A feedback system reads the positions of all moving arrays and adjusts their speeds, such that the relative spacings between moving optical assemblies remain constant.

FIG. 10 shows an embodiment of a panoramic display showing a spherical image. In some embodiments, curved optical assemblies create the spherical image in the panoramic display. Pixels (107) of the image are formed by LEDs mounted on the optical assembly, or by the ends of optical conduits. The rotating shaft 108 drives the optical assembly around the observation area, thereby forming the spherical image. An advantage of panoramic displays such as the spherical display is that the observer is presented with a full panoramic image at any observation angle. In applications where the observer is unlikely to look down or backwards, the optical assemblies are darkened for image pixels in those directions, and the optical assemblies are otherwise illuminated at other times.

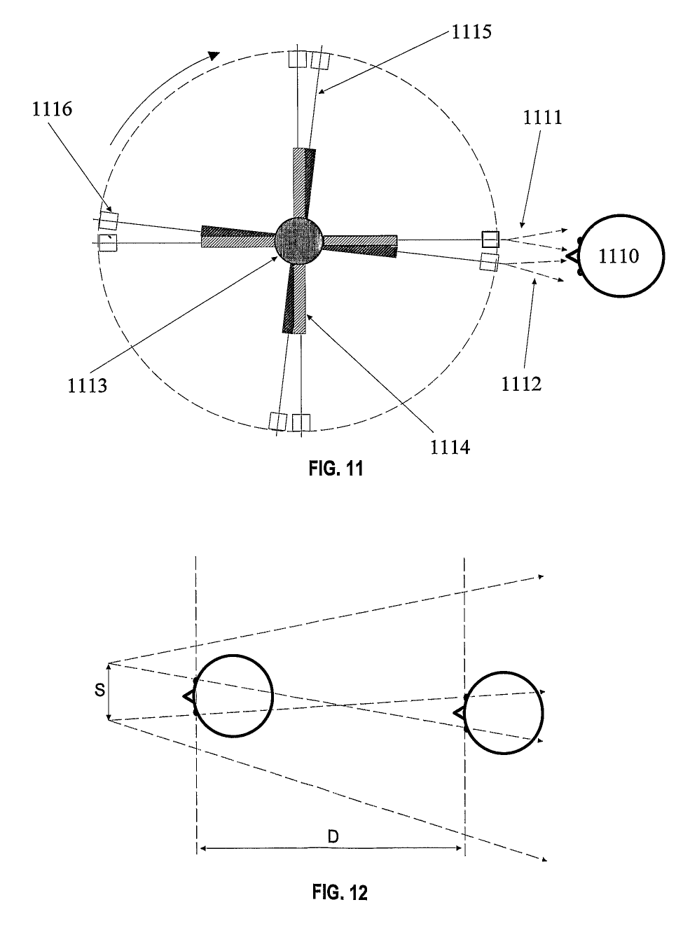

FIG. 11 shows an embodiment of a rotating display that forms a three-dimensional image, such as an autostereoscopic image. An autostereoscopic image is formed when two images with different parallax information are projected to the left and right eyes of a viewer (1110). Optical conduits (1115) mounted on LED boards (1114) are driven by rotating shaft (1113). The optical conduits (1115) terminate with optical field shaping elements (1116) that control the numerical apertures of the optical conduits (1115). The small numerical aperture allows images to be displayed as a function of viewing angle. In this way, an autostereoscopic image is formed with full parallax effects and without requiring specialized viewing glasses to be worn by viewers.

In the configuration of FIG. 11, the images displayed in different regions of the cylinder vary. FIG. 12 shows the blank region “S” in between these different regions. The distance “D” defines the region over which the images appear auto stereoscopic. D is the distance over which the image can be viewed. α is the acceptance angle of the fiber. x is the minimum distance away from the fiber where the image appears autostereoscopic. Where e is the eye spacing, (typically 6 cm):

$$\frac{e}{D} = tan ( \frac{α}{2} ) \approx N A or D \approx \frac{e}{N A} ,$$

In one embodiment with an optical fiber having a numerical aperture of 0.4, the autostereopic distance D is 15 cm. A numerical aperture of 0.1 boosts the distance D to 60 cm. In some embodiments in public areas, the autostereoscopic image is not viewed any closer than 30 cm from the optical fiber ends radiating the image. This is related to the blank distance S between two separate camera views, as follows:
S=2x.NA+e.

For x=30 cm, NA=0.1, and e=6 cm, the blank space S=12 cm, while a numerical aperture of 0.4 would require a blank space of 30 cm.

In order to reduce the effective NA at the output of the fiber, various embodiments employ the following optical field shaping elements:
1. A collimator to the end of each optical fiber.
2. A processed fiber end, such that a concave or convex shaped end achieves the desired collimation.
3. An array of lenses fixed to the output end of the optical conduits.

In general, optical field shaping elements are useful for generating image viewing tradeoffs in non-stereoscopic images as well. For example, viewing angle of the image can be optimized this way. In some embodiments, the outer end of the optical conduit is roughened to help with more efficient light extraction and more favorably distributing the output light.

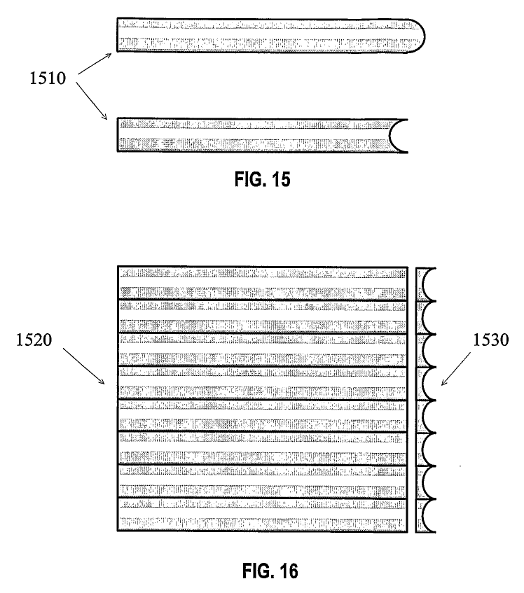

FIG. 15 shows an example of an optical fiber 1510 with a concave or convex end. FIG. 16 shows an example of array of optical fibers 1520 with an array of lenses 1530.

In an embodiment with multiple images of a scene shown on a moving display rotating cylinder with proper parallax, an observer moving around the display sees what the observer would see a if the observer were to walk around the real physical scene. The blank spaces in the display look like bars around the object. In various embodiments, such displays that vary the particular image as a function of the observer's image is formed with cylindrical or noncylindrical moving displays.

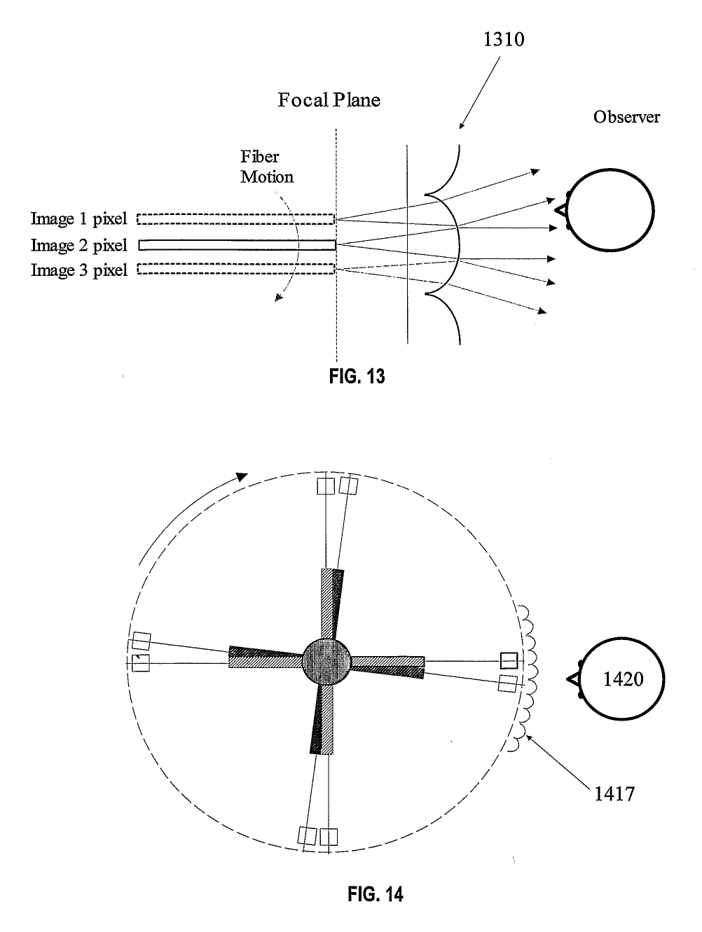

Some embodiments include a depth perception screen, such as a lenticular screen. FIG. 13 shows an example of a lenticular screen 1310 that projects different images at different viewing angles, via time-multiplexing, so that the optical conduit assembly in motion changes its pixel information in motion, and therefore in time and space. The lenticular screen is placed in front of the optical assemblies. Time multiplexing allows multiple images to be formed, without the loss of resolution, unlike purely spatial multiplexing where all light sources are permanently dedicated to a specific image.

The lenticular screen presents more than two images to the observer at any given location. FIG. 14 shows how optical conduits 1410 and 1420 carry separate images through screen 1417 for the right and left eye of the observer 1420. Display of multiple images instead of two, not only gives the observer depth perception, but it also allows him to change his view point by moving his head.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A display, comprising:
a frame surrounding an image viewing area; and
one or more optical assemblies mounted on the frame to move around the image viewing area, each of the one or more optical assemblies comprising:
a plurality of optical sources radiating optical energy to be viewed from the image viewing area; and
circuitry coupled to the plurality of optical sources to modulate the optical energy radiated by the plurality of optical sources with data of a multi-dimensional image to be viewed in the image viewing area, such that the multi-dimensional image is defined by the optical energy radiated by the plurality of optical sources as the one or more optical assemblies move around the image viewing area.

2. The display of claim 1, wherein the frame forms a circular path around the image viewing area, such that the optical assembly moves around the image viewing area along the circular path.

2. The display of claim 1, wherein the frame forms a non-circular path around the image viewing area, such that the optical assembly moves around the image viewing area along the non-circular path.

3. The display of claim 1, further comprising:
field shaping elements that control spreading of the optical energy radiated from said one or more optical assemblies in a direction toward the image viewing area.

4. The display of claim 1, wherein each of the optical assemblies includes:
a plurality of optical conduits, each of the plurality of optical conduits having:
an inner end optically coupled to at least one of the plurality of optical sources to receive optical energy from said at least one of the plurality of optical sources;
a body coupled to the inner end, the body conveying the optical energy received by the inner end; and
an outer end coupled to the body, wherein the optical energy conveyed by the body is radiated at the outer end to be viewed from the image viewing area,
wherein the optical energy defining the multi-layered image is radiated from the outer ends of the plurality of optical conduits.

5. The display of claim 1, wherein the plurality of optical sources includes a plurality of light emitting diodes.

6. The display of claim 1, wherein a first subset of the optical sources radiates optical energy to be perceived from the image viewing area at a first distance, and a second subset of the optical sources radiates optical energy to be perceived from the image viewing area at a second distance, such that the multi-dimensional image appears to have a depth dimension from the image viewing area.

7. The display of claim 1, wherein each of the optical assemblies includes:
a plurality of optical conduits, each of the plurality of optical conduits having:
an inner end optically coupled to at least one of the plurality of optical sources to receive optical energy from said at least one of the plurality of optical sources;
a body coupled to the inner end, the body conveying the optical energy received by the inner end; and
an outer end coupled to the body, wherein the optical energy conveyed by the body is radiated at the outer end to be viewed from the image viewing area,
wherein the optical energy defining the multi-dimensional image is radiated from the outer ends of the plurality of optical conduits, and
wherein the plurality of optical conduits includes a first subset of optical conduits and a second subset of optical conduits, such that a first subset of the optical sources radiates optical energy to be perceived from the image viewing area at a first distance, and a second subset of the optical sources radiates optical energy to be perceived from the image viewing area at a second distance, such that the multi-dimensional image appears to have a depth dimension from the image viewing area.

8. The display of claim 1, wherein each of the optical assemblies includes:
a plurality of optical conduits, each of the plurality of optical conduits having:
an inner end optically coupled to at least one of the plurality of optical sources to receive optical energy from said at least one of the plurality of optical sources;
a body coupled to the inner end, the body conveying the optical energy received by the inner end; and
an outer end coupled to the body, wherein the optical energy conveyed by the body is radiated at the outer end to be viewed from the image viewing area,
wherein the optical energy defining the multi-dimensional image is radiated from the outer ends of the plurality of optical conduits, and
wherein the plurality of optical conduits includes a first subset of optical conduits and a second subset of optical conduits, and said circuitry modulates the first subset and the second subset of optical conduits with three-dimensional information, such that the multi-dimensional image appears three-dimensional from the image viewing area.

9. The display of claim 1, further comprising:
an autostereoscopic element directing the optical energy from the plurality of optical sources, such that the multi-dimensional image appears three-dimensional from the image viewing area.

10. The display of claim 1, further comprising:
a lenticular screen directing the optical energy from the plurality of optical sources, such that the multi-dimensional image appears three-dimensional from the image viewing area.

11. The display of claim 1, further comprising:
a parallax screen directing the optical energy from the plurality of optical sources, such that the multi-dimensional image appears three-dimensional from the image viewing area.

12. The display of claim 1, wherein each of the optical assemblies includes:
a plurality of optical conduits, each of the plurality of optical conduits having:
an inner end optically coupled to at least one of the plurality of optical sources to receive optical energy from said at least one of the plurality of optical sources;
a body coupled to the inner end, the body conveying the optical energy received by the inner end; and
an outer end coupled to the body, wherein the optical energy conveyed by the body is radiated at the outer end to be viewed from the image viewing area,
wherein the optical energy defining the multi-dimensional image is radiated from the outer ends of the plurality of optical conduits, and
wherein the plurality of optical sources includes groups of optical sources, each of the groups including multiple optical sources radiating differently distributed optical energy, and the inner end of each of the plurality of optical conduits is optically coupled to the multiple optical sources of at least one of the groups of multiple optical sources, and the optical energy leaving the outer end of each of the plurality of optical conduits is a mixture of the differently distributed optical energy radiated from the multiple optical sources.

13. A method of displaying a multi-dimensional image, comprising:
modulating optical energy radiated by a plurality of optical sources with data of the multi-dimensional image to be viewed in an image viewing area; and
moving the plurality of optical sources around the image viewing area, such that the multi-dimensional image is defined by the optical energy radiated by the plurality of optical sources as the plurality of optical sources move around the image viewing area.

14. An apparatus forming a multi-dimensional image, comprising:
means for modulating optical energy radiated by a plurality of optical sources with data of a multi-dimensional image to be viewed in an image viewing area; and
means for moving the plurality of optical sources around the image viewing area, such that the multi-dimensional image is defined by the optical energy radiated by the plurality of optical sources as the plurality of optical sources move around the image viewing area.

15. A display, comprising:
a frame;
an autostereoscopic element directing incident optical energy, such that a multi-dimensional image from the autostereoscopic element appears three-dimensional;
one or more optical assemblies mounted on the frame to move, each of the one or more optical assemblies comprising:
a plurality of optical sources radiating optical energy to be viewed from the autostereoscopic element; and
circuitry coupled to the plurality of optical sources to modulate the optical energy radiated by the plurality of optical sources with data of the multi-dimensional image, such that the multi-dimensional image is defined by the optical energy radiated by the plurality of optical sources as the one or more optical assemblies move.

16. The display of claim 15, wherein said one or more optical assemblies move relative to the autostereoscopic element.

17. The display of claim 15, wherein the autostereoscopic element includes a lenticular screen.

18. The display of claim 15, wherein the autostereoscopic element includes a parallax screen.

19. The display of claim 15, further comprising:
field shaping elements that control spreading of the optical energy radiated from said one or more optical assemblies toward the autostereoscopic element.

20. The display of claim 15, wherein said circuitry modulates the optical energy radiated by the plurality of optical sources with a plurality of multi-dimensional images, such that each part of the autostereoscopic element shows a specific multi-dimensional image of the plurality of multi-dimensional images.

21. The display of claim 15, wherein each of the optical assemblies includes:
a plurality of optical conduits, each of the plurality of optical conduits having:
an inner end optically coupled to at least one of the plurality of optical sources to receive optical energy from said at least one of the plurality of optical sources;
a body coupled to the inner end, the body conveying the optical energy received by the inner end; and
an outer end coupled to the body, wherein the optical energy conveyed by the body is radiated at the outer end to be viewed from the autostereoscopic element,
wherein the optical energy defining the multi-dimensional image is radiated from the outer ends of the plurality of optical conduits.

22. The display of claim 15, wherein each of the optical assemblies includes:
a plurality of optical conduits, each of the plurality of optical conduits having:
an inner end optically coupled to at least one of the plurality of optical sources to receive optical energy from said at least one of the plurality of optical sources;
a body coupled to the inner end, the body conveying the optical energy received by the inner end; and
an outer end coupled to the body, wherein the optical energy conveyed by the body is radiated at the outer end to be viewed from the autostereoscopic element,
wherein the optical energy defining the multi-dimensional image is radiated from the outer ends of the plurality of optical conduits, and
wherein the plurality of optical sources includes groups of optical sources, each of the groups including multiple optical sources radiating differently distributed optical energy, and the inner end of each of the plurality of optical conduits is optically coupled to the multiple optical sources of at least one of the groups of multiple optical sources, and the optical energy leaving the outer end of each of the plurality of optical conduits is a mixture of the differently distributed optical energy radiated from the multiple optical sources.

23. A method of forming a multi-dimensional image, comprising:
modulating optical energy radiated by a plurality of optical sources with data of the multi-dimensional image; and
moving the plurality of optical sources, such that the multi-dimensional image is defined by the optical energy radiated by the plurality of optical sources as the plurality of optical sources move, and such that the multi-dimensional image from an autostereoscopic element appears three-dimensional.

24. An apparatus forming a multi-dimensional image, comprising:
means for modulating optical energy radiated by a plurality of optical sources with data of the multi-dimensional image; and
means for moving the plurality of optical sources, such that the multi-dimensional image is defined by the optical energy radiated by the plurality of optical sources as the plurality of optical sources move, and such that the multi-dimensional image from an autostereoscopic element appears three-dimensional.

25. A display, comprising:
a frame;
an optical assembly mounted on the frame to make a periodic motion about an axis, the optical assembly comprising:
a plurality of optical sources radiating optical energy; and
a plurality of optical conduits, each of the plurality of optical conduits having:
an inner end at a distance of a first radius from the axis, the inner end optically coupled to at least one of the plurality of optical sources to receive optical energy;
a body coupled to the inner end, the body conveying the optical energy received by the inner end; and
an outer end coupled to the body at a distance of a second radius from the axis, the second radius being larger than the first radius, wherein the optical energy conveyed by the body leaves at the outer end; and
circuitry coupled to the plurality of optical sources to modulate the optical energy radiated by the plurality of optical sources with data of a multi-dimensional image, such that the multi-dimensional image is defined by the optical energy leaving the outer ends of the plurality of optical conduits as the plurality of optical conduits make the periodic motion.

26. The display of claim 25, further comprising:
field shaping elements that control spreading of the optical energy radiated from said one or more optical conduits.

27. The display of claim 25, wherein a first subset of the optical sources radiates optical energy to be perceived at a first distance from the display, and a second subset of the optical sources radiates optical energy to be perceived at a second distance from the display, such that the multi-dimensional image appears to have a depth dimension.

28. The display of claim 25, wherein the plurality of optical conduits includes a first subset of optical conduits and a second subset of optical conduits, and said circuitry modulates the first subset and the second subset of optical conduits with depth information, such that the multi-dimensional image appears to have a depth dimension.

29. The display of claim 25, further comprising:
an autostereoscopic element directing the optical energy leaving the outer ends of the plurality of optical conduits, such that the multi-dimensional image appears three-dimensional.

30. The display of claim 25, further comprising:
a lenticular screen directing the optical energy leaving the outer ends of the plurality of optical conduits, such that the multi-dimensional image appears three-dimensional.

31. The display of claim 25, further comprising:
a parallax screen directing the optical energy leaving the outer ends of the plurality of optical conduits, such that the multi-dimensional image on the lenticular screen appears three-dimensional.

32. The display of claim 25, wherein the plurality of optical sources includes groups of optical sources, each of the groups including multiple optical sources radiating differently distributed optical energy, and the inner end of each of the plurality of optical conduits is optically coupled to the multiple optical sources of at least one of the groups of multiple optical sources, and the optical energy leaving the outer end of each of the plurality of optical conduits is a mixture of the differently distributed optical energy radiated from the multiple optical sources.

33. A method of forming a multi-dimensional image with a plurality of optical conduits having inner ends at one or more first radii from an axis, bodies conveying the optical energy received by the inner ends, and outer ends at one or more second radii from the axis radiating the optical energy conveyed by the bodies, comprising:
modulating optical energy generated by a plurality of optical sources with data for the multi-dimensional image; and
moving the plurality of optical conduits about the axis, such that the multi-dimensional image is defined by the optical energy leaving the outer ends of the plurality of optical conduits as the plurality of optical conduits move.

34. An apparatus forming a multi-dimensional image with a plurality of optical conduits having inner ends at one or more first radii from an axis, bodies conveying the optical energy received by the inner ends, and outer ends at one or more second radii from the axis radiating the optical energy conveyed by the bodies, comprising:
means for modulating optical energy generated by a plurality of optical sources with data for the multi-dimensional image; and
means for moving the plurality of optical conduits about the axis, such that the multi-dimensional image is defined by the optical energy leaving the outer ends of the plurality of optical conduits as the plurality of optical conduits move.
